(19) United States
(12) Patent Application Publication
(10) Pub. No.: US 2025/0142277 A1
(43) Pub. Date: May 1, 2025

(54) INCREMENTAL HEAD-RELATED TRANSFER FUNCTION UPDATES

(71) Applicant: GOOGLE LLC, Mountain View, CA (US)

(72) Inventor: Dongeek Shin, San Jose, CA (US)

(21) Appl. No.: 18/934,895

(22) Filed: Nov. 1, 2024

Related U.S. Application Data
(60) Provisional application No. 63/595,118, filed on Nov. 1, 2023.

(51) Int. Cl. H04S 7/00

(52) U.S. Cl. CPC H04S 7/00; H04S 2420/01

(57) ABSTRACT

Disclosed implementations for generating personalized audio. Sensor data corresponding with at least one physical characteristic of a user is received. A three-dimensional mesh of the user is updated based on the sensor data. An impulse response for the user is determined based on the three-dimensional mesh. An audio stream is generated based on the impulse response.

### BACKGROUND

Sound reproduction is the process of recording, processing, storing, and recreating sound, such as speech, music, and the like. When recording a sound, one or more audio sensors are used to capture sound in single or multiple positions for a recording device.

### SUMMARY

An audio signal can be customized for a listener using a personalized audio profile. The personalized audio profile can be a type of audio listening profile configured specifically for the listener and may include an impulse response generated based on the user's physical characteristics. Current approaches for generating a personalized audio profile for a listener include making measurements for the listener in an anechoic chamber using audio equipment. At least one technical problem with this approach is that such an approach is expensive and not feasible with typical user computing devices.

The personalized audio profiles determined in the example implementation above can be employed to render audio tailored specifically to the unique physical characteristics of the listener and thereby making the experience more immersive. The personalized audio profile may be referred to as a personalized response or as a personalized impulse response. Accordingly, in one example, a method includes receiving sensor data corresponding with at least one physical characteristic of a user; updating a three-dimensional mesh of the user based on the sensor data; determining an impulse response for the user based on the three-dimensional mesh; and generating an audio stream based on the impulse response.

It is appreciated that methods and systems, in accordance with the present disclosure, can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

The following detailed description that sets forth aspects of the subject matter, along with the accompanying drawings of which:

FIG. 1 is an example environment where a device is employed to determine a personalized impulse response for a user, according to an implementation of the described system;

FIG. 2 is an example architecture that can be employed to execute implementations of the present disclosure;

FIG. 3 is an example environment that can be employed to execute implementations of the present disclosure;

FIG. 4 is a flowchart of a non-limiting process that can be performed by implementations of the present disclosure; and

FIG. 5 is an example system that includes a computer or computing device that can be programmed or otherwise configured to implement systems or methods of the present disclosure.

### DETAILED DESCRIPTION

Humans locate sounds in three dimensions, even though we have only two ears, because the brain, inner ear, and the external ears (pinna) work together to make inferences about location. Generally, humans can estimate the location of a source of a sound based on cues derived from one ear (monaural cues) that are compared to cues received at both ears (difference cues or binaural cues). Among these difference cues are time differences of arrival of sounds and intensity differences of sounds. For example, sound travels outward from a sound source in all directions via sound waves that reverberate (or reflect) off of objects near the sound source. These sound waves bounce off an object and/or portions of the listener's body and can be altered in response to the impact. When the sound waves reach a listener (either directly from the source and/or after reverberating off an object[s]) they are converted by a listener's body and interpreted by the listener's brain. Accordingly, sounds are interpreted and processed by a listener in a personalized way based on the unique physical characteristics of the listener.

Sounds reproduced using audio equipment can be personalized or customized for a listener in a personalized audio profile, which can be used to improve the listening experience of the listener based on one or more of their physical characteristics. At least one technical problem with current approaches for generating such a personalized audio profile for a listener is that the current approaches often involve the use of complicated techniques and expensive equipment for making measurements for the listener. For example, as noted above, current approaches for generating a personalized impulse response include measurements collected in an anechoic chamber using audio equipment. Such an approach does not scale to consumer devices. Moreover, measurements collected in an anechoic chamber take a considerable amount of time and the process is not user-friendly.

At least one of the technical solutions to the technical problem described above includes generating personalized audio for a listener from data collected by the listener (and for the listener) using a typical personal computing device (e.g., a mobile device). The personalized audio can be used to render audio tailored specifically to the unique physical characteristics of the listener and thereby make the listening experience more immersive. The personalized audio profile can be generated (e.g., defined) using a variety of techniques including the use of impulse responses, transfer functions, and/or convolutions. Some aspects of impulse responses, transfer functions, and convolutions are described in more detail below by way of introduction.

A listener derives the monaural cues from the interaction between a sound source and the listener's anatomy where the original source sound is modified before entering the ear canal for processing by the auditory system. These modifications encode the source location and may be captured via an impulse response (also can be referred to as a response or as an audio response) that relates the source location and the ear location. More generally, the impulse response is the reaction of any dynamic system (e.g., the listener) in response to some external change (e.g., the audio signal). The impulse response can be configured to characterize the reaction of the dynamic system as a function of time (or possibly as a function of some other independent variable that parametrizes the dynamic behavior of the system). In some implementations, this impulse response is termed the head-related impulse response (HRIR) in the context of a listener's response to an audio signal.

A transfer function is an integral transform, specifically a Fourier transform, of an impulse response. An integral transform can be an operation that converts or maps a function from its original function space (a set of functions between two fixed sets) into another function space. This transfer function can be referred to as the head-related transfer function (HRTF) and describes the spectral characteristics of sound measured at the tympanic membrane (the eardrum) when the source of the sound is in three-dimensional space. A transfer function, and specifically an HRTF, can be used to simulate externally presented sounds when the sounds are introduced through, for example, headphones. More generally, an HRTF is a function of frequency, azimuth, and elevation determined primarily by the acoustical properties of the external ear, the head, and the torso of an individual. As such, HRTFs can differ substantially across individuals. In this case, the function space of the impulse response is the time domain (how a frequency changes over time) while the function space of the transfer function is the frequency domain (how a signal is distributed within different frequency bands over a range of frequencies). However, both the impulse response (e.g., HRIR) and the transfer function (HRTF), in some implementations, can characterize the transmission between a sound source and the eardrums of a listener.

Said differently, how an ear receives a sound (e.g., sound waves) from a point in space (e.g., a sound source) can be characterized using a transfer function or an impulse response. Both the impulse response and transfer function describe the acoustic filtering or modifications to a sound, due to the presence of a listener (and/or any object), from a direction to the sound as the sound propagates in free field and arrives at the ear (more specifically the eardrum). In some implementations, both the impulse response and transfer function describe the acoustic filtering or modifications to a sound, due to the presence of an object, from a direction to the sound as the sound propagates in free field and arrives at a portion of the object. As sound reaches the listener, the shape of the listener's body (especially the shape of the listener's head and pinnae) modifies the sound and affects how the listener perceives the sound. Specifically, an HRTF is defined as the ratio between the Fourier transform of the sound pressure at the entrance of the ear canal and the Fourier transform of the sound pressure in the middle of the head in the absence of the listener. HRTFs are therefore filters quantifying the effect of the shape of the head, body, and pinnae on the sound arriving at the entrance of the ear canal.

These modifications include, most notably, the shape of the listener's ear (especially the shape of the listener's outer ear); the shape, size, and mass, of the listener's head and body; the length and diameter of the ear canal; the dimensions of the oral and sinus cavities; as well as the acoustic characteristics of the space in which the sound is played can all manipulate the incoming sound waves by boosting some frequencies and attenuating others. All of these characteristics influence how (or whether) a listener can determine the direction of the sound's source (e.g., from where the sound is coming). These modifications create a unique perspective and perception for each listener as well as help the listener pinpoint the location of the sound source.

A convolution can include the process of multiplying the frequency spectra of two audio sources such as, for example, an input audio signal and an impulse response. The frequencies that are shared between the two sources are accentuated, while frequencies that are not shared are attenuated. Convolution causes an input audio signal to take on the sonic qualities of the impulse response, as characteristic frequencies from the impulse response common in the input signal are boosted. Put another way, convolution of an input sound source with the impulse response converts the sound to that which would have been heard by the listener if the sound had been played at the source location, with the listener's ear at the receiver location. In this way, impulse responses (e.g., an HRIR or an HRTFs) are used to produce virtual surround sound.

A convolution is more efficient (e.g., becomes a multiplication) in the frequency (Fourier) domain and therefore transfer functions are preferred when generating an audio signal for an individual via convolution. Accordingly, a pair of transfer functions (e.g., one HRTF for each ear) can be used to synthesize a binaural sound that is perceived as originating from a particular point in space. Moreover, some consumer home entertainment products designed to reproduce surround sound from stereo audio devices (e.g., two or more speakers) can use some form of a transfer function(s). Some forms of transfer function processing have also been included in computer software to simulate surround sound playback from loudspeakers. The transfer function can then be used to generate an audio signal. For example, a binaural audio signal that is specifically tailored to a user (e.g., via headphones or loudspeakers).

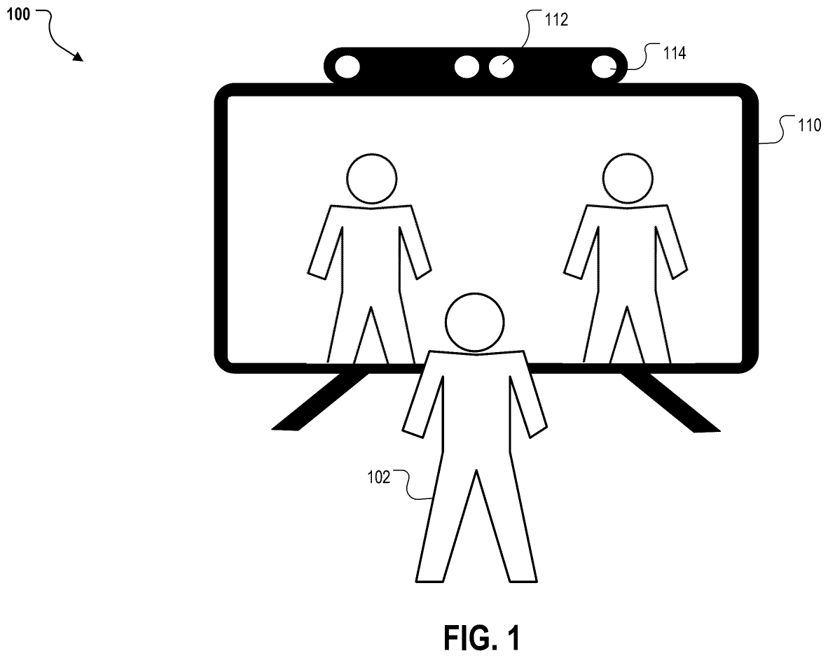

FIG. 1 illustrates a block diagram of an example environment 100 (e.g., a room) where a device 110 is employed by a user 102 to determine a personalized impulse response for the user 102 according to implementation of the described system. The device 110 can be configured to generate personalized audio for a listener from data collected by the listener (and for the listener) using the device 110. The personalized audio can be used to render audio tailored specifically to the unique physical characteristics of the user 102 and thereby make a listening experience more immersive for the user 102. The personalized audio profile can be generated (e.g., defined) using a variety of techniques including the use of impulse responses, transfer functions, and convolutions, which are described in more detail below.

The device 110 includes one or more sensors 112 and one or more electroacoustic transducers 114. The one or more sensors 112 are devices (e.g., a camera, IMU sensors, and the like) configured to detect and convey information in the form of images, IMU data, and the like. In some cases, IMU data includes motion data in a time-series format. This motion data may include acceleration measurements as well as angular velocity measurements, which can be represented in a three-axis coordinate system and together yield a six-dimension measurement time series stream. The one or more electroacoustic transducers 114 (e.g., a loudspeaker) are devices configured to convert an electrical signal into sound waves.

As depicted, the user 102 may use the device 110 for video related activities, such as video conferencing. The device 110 is configured to update an impulse response for the user 102 as the user engages with the device 110. The impulse response may be employed to generate a transfer function (i.e., an integral transform of the impulse response) that can be used to generate audio customized for the user 102. In some cases, the device 110 gathers visual information, via the one or more sensors 112, about the user 102 in the background while the user is naturally using the device. In some implementations, the device may collect information about the user 102 or a remote user as the user moves about an environment. In some implementations, the device 110 identifies part of the body of the user 102 during a session. In some implementations, the device 110 is configured to employ a dense non-rigid fusion method that can aggregate the imaging data collected by the one or more sensors 112 and constantly update a representation (e.g., a 3D mesh) of the user 102 (or another remote user).

The representation is then used to determine the personalized impulse response for the respective user. A personalized transfer function can then be obtained from the personalized impulse response by applying a transform. For discrete-time systems, the Z-transform (which converts a discrete-time signal into a complex valued frequency-domain representation) may be used. For continuous-time systems, the Laplace transform (an integral transform that converts a function of a real variable to a function of a complex variable) may be used. The Z-transform can be considered a discrete-time equivalent of the Laplace transform. For a conventional 3D audio effect, for example, the device 110 is configured to spatially localize the user's ears using the one or more sensors 112. The device 110 may then phase-engineer audio, which can be broadcast to the user via the one or more electroacoustic transducers 114, to ensure the binaural audio hits the user's 102 left and right ears matches intended audio content.

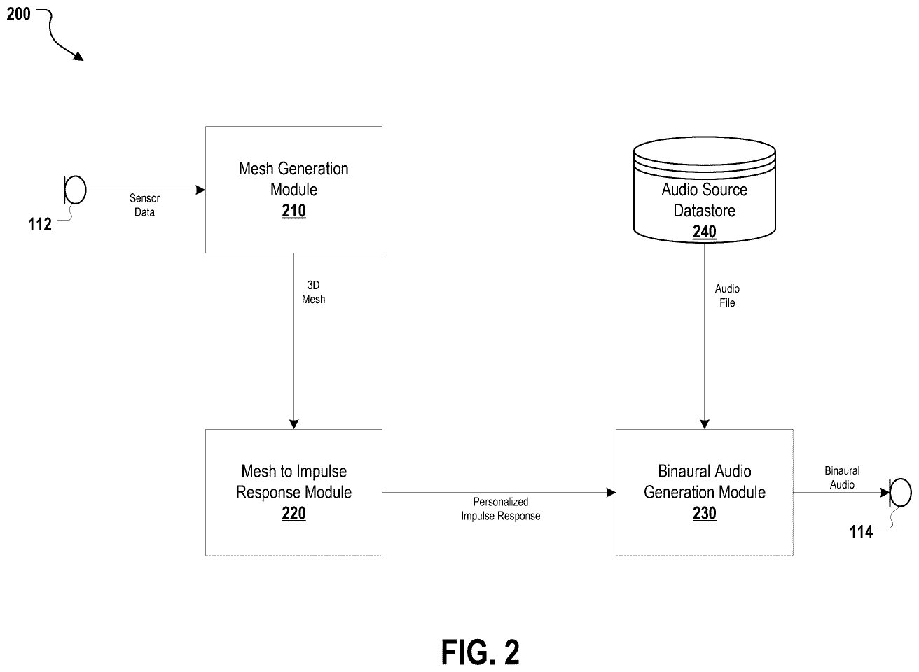

In some implementations (as described in more detail below with reference to FIG. 2) the device 110 employs incremental meshing block (as described below with reference to architecture 200) based on a 3D snapshot, non-rigid fusion, an updated mesh, and a generative model trained to convert the updated mesh to a personalized impulse response of the user 102. In some cases, the device 110 is configured to execute this block on a sparse inference frequency. Put another way, the timing for executing the block can be configured to address various aspects of a particular task executed by the device 110. For example, with respect to the inference frequency, there is a trade-off between latency (the time it takes for the user to have a reliable transfer function generated from the personalized impulse response and reliable sound experience) and accuracy (producing a personalized impulse response for a quality user sound experience). In some implementations, the frequency for executing the block can be less than every frame. In some implementations, the inference frequency can be sparse because useful new mesh part updates can be performed in, for example, seconds, with natural user movement.

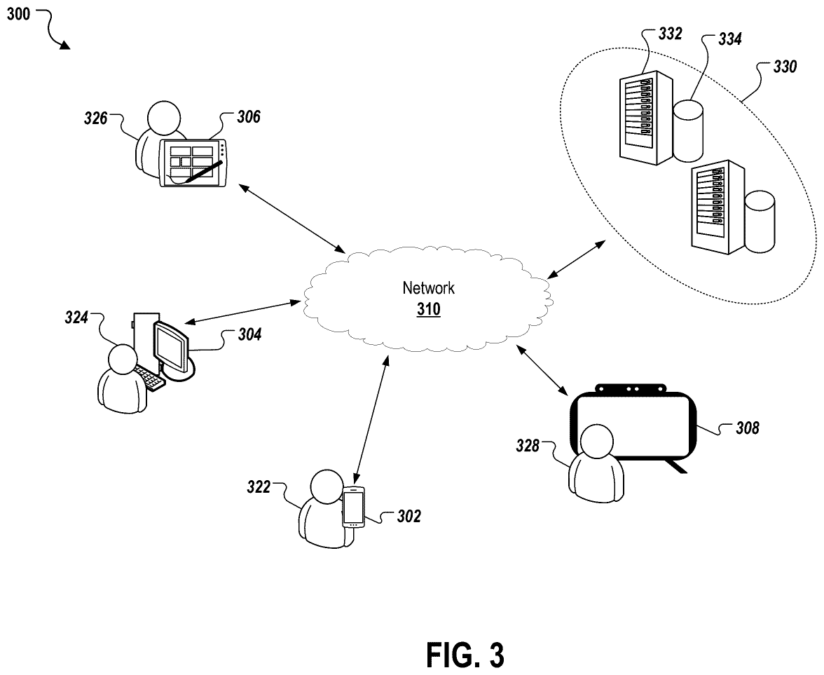

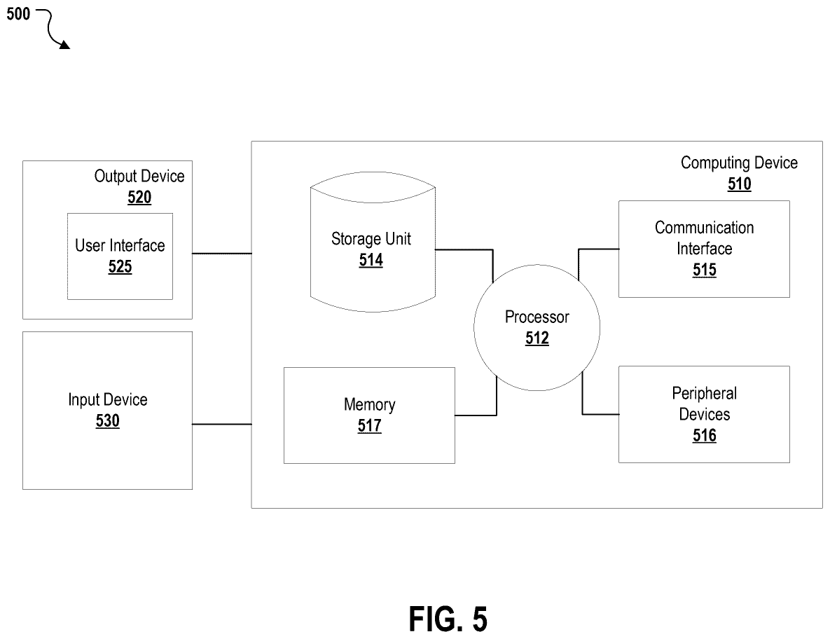

The device 110 is substantially similar to computing device 510 depicted below with reference to FIG. 5. Moreover, device 110 is depicted as a teleconferencing device in FIG. 1; however, it is contemplated that implementations of the present disclosure can be realized with any of the appropriate computing device(s), such as the computing devices 302, 304, 306, and 308 described below with reference to FIG. 3.

FIG. 2 is a block diagram of an example architecture 200 for the above-described incremental meshing block. The example architecture 200 can be employed for the computation of a personalized impulse response. As depicted, the example architecture 200 includes mesh generation module 210, mesh to impulse response module 220, and mesh to impulse response module 230, and audio source datastore 240. In some implementations, the modules 210, 220, and 230 are executed via an electronic processor of the device 110, depicted in FIG. 1. In some implementations, the modules 210, 220, and 230 are provided via a back-end system (such as the back-end system 330 described below with reference to FIG. 3) and the device 110 is configured to communicate with the back-end system via a network (such as the communications network 310 described below with reference to FIG. 3).

In some implementations, the mesh generation module 210 processes the sensor data (e.g., image data, IMU data, and the like) collected by the one or more sensors 112 to generate and/or update a 3D mesh representing the physical body of a user (e.g., user 102) created based on the fused snapshots of the user. In some cases, a 3D mesh is a mathematical coordinate-based representation (i.e., a model) of an object (e.g., the user 102) in three dimensions. The 3D mesh represents a physical body using a collection of points in 3D space, connected by various geometric entities such as triangles, lines, curved surfaces, and the like. In some implementations, the mesh generation module 210 generates the 3D mesh by manipulating edges, vertices, and polygons in a simulated 3D space.

In some cases, the sensor data provided via the one or more sensors 112 include snapshots of the user. In some cases, the snapshots include images of the user captured during normal use of, for example, a teleconferencing application. In some implementations, the mesh generation module 210 processes the received sensor data by mapping the user, via non-rigid fusion, based on the snapshots. In some cases, the mesh generation module 210 is configured to fuse the snapshots to create a representation of the user regardless of the orientation and/or the location of the user with respect to the one or more sensors 112. In some cases, the representation is a fused snapshot representation. In some cases, the representation is a single channel representation that may not be red, green and blue (RGB) as, in some cases, only the geometry represented in the 3D mesh is used to generate a personalized audio profile (e.g., a personalized impulse response) for the user. In some implementations, the mesh generation module 210 is configured to update the 3D mesh associated with a based on the last N snapshots. In other words, the updated 3D mesh may represent a real-time dynamically updated mesh representation of a user based on the fused snapshots that represent the user.

In some implementations, the mesh to impulse response module 220 is configured to generate a personalized impulse response based on the 3D mesh as updated by the mesh generation module 210. In some implementations, the mesh to impulse response module 220 employs a generative model to convert the 3D mesh to an impulse response. In some cases, the generative model is a custom neural network that converts a mesh input to a spherical coordinate parametrized personalized impulse response for the user. In some cases, the generative model is trained to provide a personalized transfer function (e.g., an HRTF) for the user based on the 3D mesh. In some cases, the generative model is trained to provide a personalized transfer function (or HRTF) for each of the user's ears). In some implementations, the generative model is based on graph neural regressors—given an input spatial structure.

In some implementations, the mesh to impulse response module 220 converts the 3D mesh into a voxelized 3D grid (a 3D grid of values organized into layers of rows and columns where intersection of a row, column, and layer is a “voxel” (i.e., a smaller 3D cube). In some cases, each voxel the voxelized 3D grid includes a one when a valid mesh is intercepting the voxel and a zero when no mesh triangle is included in the voxel. In some implementations, the mesh to impulse response module 220 processes the voxelized 3D grid through the generative model (i.e., processes the voxelized 3D grid through several, such as two or more, convolutional layers to condenses the information down to a single embedding vector). In some implementations, the generative model is configured to up-convolve the embedding vector to compute two output heads—one for each ear. Each head will provide an output of N×M which describes the HRTF spectrum vs. direction. In some implementations, the generative model is configured (e.g., trained) with full backpropagation over the whole network (i.e., not two networks trained separately).

In some implementations, the impulse response module 230 is configured binaural audio based on the personalized impulse responses provided by the mesh to impulse response module 220. In some implementations, the impulse response module 230 generates a binaural audio signal from a source audio file. In some cases, the source audio file may be stored to an audio source datastore 240. In some cases, the source audio file may be received from a back-end system (such as the back-end system 330 described below with reference to FIG. 3) via a network (such as the communications network 310 described below with reference to FIG. 3). In some cases, the audio file may be provided via a user device such as the computing devices 302, 304, 306, and 308 described below with reference to FIG. 3.

In some implementations, the impulse response module 230 is configured to provide the binaural audio signal to the one or more electroacoustic transducers 114. For example, the user device 110 may be configured to generate a binaural audio signal when the user 102 is engaged in a teleconference using the personalized impulse response generated for the user based on the most recently updated 3D mesh for the user.

FIG. 3 depicts an example environment 300 that can be employed to execute implementations of the present disclosure. The example environment 300 includes computing devices 302, 304, 306, 308; a back-end system 330, and a communications network 310. The communications network 310 may include wireless and wired portions. In some cases, the communications network 310 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communications network 310 may also include future developed networks. In some implementations, the communications network 310 includes the Internet, an intranet, an extranet, or an intranet and/or extranet that is in communication with the Internet. In some implementations, the communications network 310 includes a telecommunication or a data network.

In some implementations, the communications network 310 connects web sites, devices (e.g., the computing devices 302, 304, 306, and 308) and back-end systems (e.g., the back-end system 330). In some implementations, the communications network 310 can be accessed over a wired or a wireless communications link. For example, mobile computing devices (e.g., the computing device 302 can be a smartphone device and the computing device 406 can be a tablet device), can use a cellular network to access the communications network 310. In some examples, the users 322, 324, 326, and 328 interact with the system through a graphical user interface (GUI) (e.g., the user interface 525 described below with reference to FIG. 5) or client application (e.g., a teleconferencing application) that is installed and executing on their respective computing devices 302, 304, 306, or 308.

In some examples, the computing devices 302, 304, 306, and 308 provide viewing data (e.g., teleconferencing data and/or images from an imaging sensor, such as the one or more sensors 112 described above with reference to FIG. 1) to screens with which the users 322, 324, 326, and 326, can interact. In some examples, the computing devices 302, 304, 306, and 308 are configured to determine a personalized impulse response and provide audio signals generated with the personalized impulse response (or the related personalize transfer function) to the respective users 322, 324, 326, and 326 according to implementations of the present disclosure.

In some cases, the computing devices 302, 304, 306, and 308 are configured to determine a personalized impulse response for multiple users according to implementations of the present disclosure. In such cases, the computing devices 302, 304, 306, and 308 may be configured to provide an audio stream (e.g., to headphones or a loudspeaker) generated based on the user's personalized impulse response or personalized transfer function. In some cases, the computing devices 302, 304, 306, and 308 may be configured to simultaneously provide audio signals generated for multiple users based on the user's respective personalized impulse response. For example, the computing devices 302, 304, 306, and 308 may be configured to provide a first audio signal to a first user (e.g., via a first pair of connected headphones) generated based on a first personalized impulse response associated with the first user while also providing a second audio signal to a second user (e.g., via a second pair of connected headphones) generated based on a second personalized impulse response associated with the second user.

In some implementations, the computing devices 302, 304, 306 and 308 are substantially similar to the computing device 510 described below with reference to FIG. 5. The computing devices 302, 304, 306, and 308 may include (e.g., may each include) any appropriate type of computing device, such as a desktop computer, a laptop computer, a handheld computer, a tablet computer, a teleconferencing device, a personal digital assistant (PDA), an AR/VR/XR device, a cellular telephone, a network appliance, a camera, a smartphone, an enhanced general packet radio service (EGPRS) mobile phone, a media player, a navigation device, an email device, a game console, or an appropriate combination of any two or more of these devices or other data processing devices.

Four computing devices 302, 304, 306 and 308 are depicted in FIG. 3 for simplicity. In the depicted example environment 300, the computing device 302 is depicted as a smartphone, the computing device 304 is depicted as a tablet-computing device, the computing device 306 is depicted as a desktop computing device, and the computing device 408 is depicted as a teleconferencing device. It is contemplated, however, that implementations of the present disclosure can be realized with any of the appropriate computing devices, such as those mentioned previously. Moreover, implementations of the present disclosure can employ any number of devices.

In some implementations, the back-end system 330 includes at least one server device 332 and optionally, at least one data store 334. In some implementations, the server device 332 is substantially similar to computing device 510 depicted below with reference to FIG. 5. In some implementations, the server device 332 is a server-class hardware type device. In some implementations, the back-end system 330 includes computer systems using clustered computers and components to function as a single pool of seamless resources when accessed through the communications network 310. For example, such implementations may be used in data center, cloud computing, storage area network (SAN), and network attached storage (NAS) applications. In some implementations, the back-end system 330 is deployed using a virtual machine(s).

In some implementations, the data store 334 is a repository for persistently storing and managing collections of data. Example data stores that may be employed within the described system include data repositories, such as a database as well as simpler store types, such as files, emails, and so forth. In some implementations, the data store 334 includes a database. In some implementations, a database is a series of bytes or an organized collection of data that is managed by a database management system (DBMS). In some implementations, the audio source datastore 240 is implemented via the data store 334.

In some implementations, the back-end system 330 hosts one or more computer-implemented services provided by the described system with which users 322, 324, 326, and 326 can interact using the respective computing devices 302, 304, 306, and 308. For example, in some cases, the back-end system 330 is configured to connect the computing devices 302, 304, 306, and 308 via a teleconferencing application. In some cases, the back-end system 330 is configured to provide audio data to the computing devices 302, 304, 306, and 308, which is converted to binaural audio according to implementation described herein.

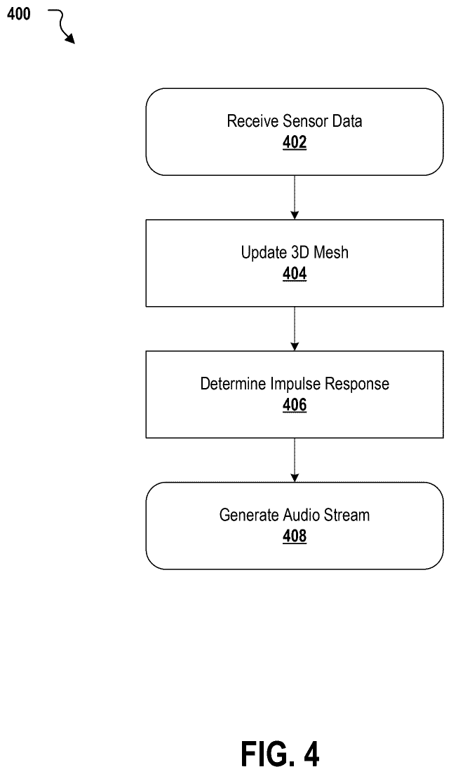

FIG. 4 depicts a flowchart of an example process 400 that can be implemented by implementations of the present disclosure. The example process 400 can be implemented by systems and components described with reference to FIGS. 1-3 and 5. The example process 400 generally shows in more detail how a personalized impulse response is determined or updated based on sensor data (e.g., video and/or ICU data).

For clarity of presentation, the description that follows generally describes the example process 400 in the context of FIGS. 1-3 and 5. However, it will be understood that the process 400 may be performed, for example, by any other suitable system, environment, software, and hardware, or a combination of systems, environments, software, and hardware as appropriate. In some implementations, various operations of the process 400 can be run in parallel, in combination, in loops, or in any order.

At 402, sensor data corresponding with at least one physical characteristic of a user is received. In some implementations, the sensor data is captured by a camera and an inertial measurement unit sensor of a computing device (e.g., the computing devices 302, 304, 306, or 308 depicted in FIG. 3). In some implementations, the sensor data includes a snapshot of the user. In some implementations, the at least one physical characteristic of the user includes a first ear and a second ear. In some implementations, the sensor data includes images captured by an imaging device.

From 402, the process 400 proceeds to 404 where a three-dimensional mesh of the user is updated based on the sensor data. In some implementations, the three-dimensional mesh is updated based on the sensor data according to a sparse inference frequency. In some implementations, the three-dimensional mesh is updated by mapping the user via non-rigid fusion using the snapshot. In some implementations, the three-dimensional mesh of the user includes information related to a most recent number of snapshots of the user. In some implementations, the number of snapshots is set based on threshold value.

From 404, the process 400 proceeds to 406 where an impulse response for the user is generated based on the three-dimensional mesh. In some implementations, the impulse response for the user is determined by processing the three-dimensional mesh through a generative model. In some implementations, the impulse response is a first impulse response associated with the first ear. In some implementations, a second impulse response associated with the second ear is determined. In some implementations, the generative model is configured to convert the three-dimensional mesh to a voxelized three-dimensional grid to determine the embedding vector. In some implementations, the generative model is configured to process the three-dimensional mesh to determine an embedding vector and up-convolve the embedding vector to compute a first output head corresponding to a first ear of the user and a second output head corresponding to a second ear of the user.

From 406, the process 400 proceeds to 408 where an audio stream is generated based on the impulse response. In some implementations, the audio stream is generated based on the first impulse response and the second impulse response. In some implementations, the audio stream is generated by determining a first transfer function based on the first output head and a second transfer function based on the second output head and generating the audio stream by multiplying frequency spectra of an audio source and the first transfer function and the second transfer function. In some implementations, the audio stream provides a binaural sound of an audio source. In some implementations, the audio stream is provided via an electroacoustic transducer (e.g., a loudspeaker connected to one of the computing devices 302, 304, 306, or 308 depicted in FIG. 3) as binaural audio to the user (e.g., the respective users 322, 324, 326, or 328 depicted in FIG. 3).

In some implementations, a transfer function is determined based on an integral transform of the impulse response for the user. In some implementations, the transfer function is a Fourier transform of the impulse response. In some implementations, the audio stream is generated by multiplying frequency spectra of an audio source and the transfer function. From 408, the process 400 repeats or ends.

FIG. 5 depicts an example computing system 500 that includes a computer or computing device 510 that can be programmed or otherwise configured to implement systems or methods of the present disclosure. For example, the computing device 510 can be programmed or otherwise configured to implement the process 400. In some cases, the computing device 510 includes an operating system configured to perform executable instructions. The operating system is, for example, software, including programs and data that manages the device's hardware and provides services for execution of applications.

In the depicted implementation, the computer or computing device 510 includes an electronic processor (also “processor” and “computer processor” herein) 512, such as a central processing unit (CPU) or a graphics processing unit (GPU), which is optionally a single core, a multi core processor, or a plurality of processors for parallel processing. The depicted implementation also includes memory 517 (e.g., random-access memory, read-only memory, flash memory), storage unit 514 (e.g., hard disk or flash), communication interface module 515 (e.g., a network adapter or modem) for communicating with one or more other systems, and peripheral devices 516, such as cache, other memory, data storage, microphones, speakers, and the like. In some implementations, the memory 517, storage unit 514, communication interface module 515 and peripheral devices 516 are in communication with the electronic processor 512 through a communication bus (shown as solid lines), such as a motherboard. In some implementations, the bus of the computing device 510 includes multiple buses. The above-described hardware components of the computing device 510 can be used to facilitate, for example, an operating system and operations of one or more applications executed via the operating system. For example, a virtual representation of space may be provided via the user interface 525. In some implementations, the computing device 510 includes more or fewer components than those illustrated in FIG. 5 and performs functions other than those described herein.

In some implementations, the memory 517 and storage unit 514 include one or more physical apparatuses used to store data or programs on a temporary or permanent basis. In some implementations, the memory 517 is volatile memory and can use power to maintain stored information. In some implementations, the storage unit 514 is non-volatile memory and retains stored information when the computer is not powered. In further implementations, memory 517 or storage unit 514 is a combination of devices such as those disclosed herein. In some implementations, memory 517 or storage unit 514 is distributed across multiple machines such as a network-based memory or memory in multiple machines performing the operations of the computing device 510.

In some cases, the storage unit 514 is a data storage unit or data store for storing data. In some instances, the storage unit 514 stores files, such as drivers, libraries, and saved programs. In some implementations, the storage unit 514 stores data received by the device (e.g., audio data). In some implementations, the computing device 510 includes one or more additional data storage units that are external, such as located on a remote server that is in communication through a network (e.g., the communications network 310 described above with reference to FIG. 3).

In some implementations, platforms, systems, media, and methods as described herein are implemented by way of machine or computer executable code stored on an electronic storage location (e.g., non-transitory computer readable storage media) of the computing device 510, such as, for example, on the memory 517 or the storage unit 514. In further implementations, a computer readable storage medium is optionally removable from a computer. Non-limiting examples of a computer readable storage medium include compact disc read-only memories (CD-ROMs), digital versatile discs (DVDs), flash memory devices, solid state memory, magnetic disk drives, magnetic tape drives, optical disk drives, cloud computing systems and services, and the like. In some cases, the computer executable code is permanently, substantially permanently, semi-permanently, or non-transitorily encoded on the media.

In some implementations, the electronic processor 512 is configured to execute the code. In some implementations, the machine executable or machine-readable code is provided in the form of software. In some examples, during use, the code is executed by the electronic processor 512. In some cases, the code is retrieved from the storage unit 514 and stored on the memory 517 for ready access by the electronic processor 512. In some situations, the storage unit 514 is precluded, and machine-executable instructions are stored on the memory 517.

In some cases, the electronic processor 512 is a component of a circuit, such as an integrated circuit. One or more other components of the computing device 510 can be optionally included in the circuit. In some cases, the circuit is an application specific integrated circuit (ASIC) or a field programmable gate arrays (FPGAs). In some cases, the operations of the electronic processor 512 can be distributed across multiple machines (where individual machines can have one or more processors) that can be coupled directly or across a network.

In some cases, the computing device 510 is optionally operatively coupled to a communications network, such as the communications network 310 described above with reference to FIG. 3, via the communication interface module 515, which may include digital signal processing circuitry. Communication interface module 515 may provide for communications under various modes or protocols, such as global system for mobile (GSM) voice calls, short message/messaging service (SMS), enhanced messaging service (EMS), or multimedia messaging service (MMS) messaging, code-division multiple access (CDMA), time division multiple access (TDMA), wideband code division multiple access (WCDMA), CDMA2000, or general packet radio service (GPRS), among others. Such communication may occur, for example, through a transceiver. In addition, short-range communication may occur, such as using a BLUETOOTH, WI-FI, or other such transceiver.

In some cases, the computing device 510 includes or is in communication with one or more output devices 520. In some cases, the output device 520 includes a display to send visual information to a user. In some cases, the output device 520 is a touch sensitive display that combines a display with a touch sensitive element that is operable to sense touch inputs as and functions as both the output device 520 and the input device 530. In still further cases, the output device 520 is a combination of devices such as those disclosed herein. In some cases, the output device 520 displays a user interface 525 generated by the computing device.

In some cases, the computing device 510 includes or is in communication with one or more input devices 530 that are configured to receive information from a user. In some cases, the input device 530 is a keyboard. In some cases, the input device 530 is a keypad (e.g., a telephone-based keypad). In some cases, the input device 530 is a cursor-control device including, by way of non-limiting examples, a mouse, trackball, trackpad, joystick, game controller, or stylus. In some cases, as described above, the input device 530 is a touchscreen or a multi-touchscreen. In other cases, the input device 530 is a microphone to capture voice or other sound input. In other cases, the Input device 530 is an imaging device such as a camera. In still further cases, the input device is a combination of devices such as those disclosed herein.

It should also be noted that a plurality of hardware and software-based devices, as well as a plurality of different structural components may be used to implement the described examples. In addition, implementations may include hardware, software, and electronic components or modules that, for purposes of discussion, may be illustrated and described as if most of the components were implemented solely in hardware. In some implementations, the electronic-based aspects of the disclosure may be implemented in software (e.g., stored on non-transitory computer-readable medium) executable by one or more processors, such as electronic processor 512. As such, it should be noted that a plurality of hardware and software-based devices, as well as a plurality of different structural components may be employed to implement various implementations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated. As used herein, the term “real-time” refers to transmitting or processing data without intentional delay given the processing limitations of a system, the time required to accurately obtain data and images, and the rate of change of the data and images. In some examples, “real-time” is used to describe the presentation of information obtained from components of implementations of the present disclosure.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method comprising:
receiving sensor data corresponding with at least one physical characteristic of a user;
updating a three-dimensional mesh of the user based on the sensor data;
determining an impulse response for the user based on the three-dimensional mesh; and
generating an audio stream based on the impulse response.

2. The method of claim 1, further comprising:
updating the three-dimensional mesh based on the sensor data according to a sparse inference frequency.

3. The method of claim 1, wherein the sensor data includes a snapshot of the user, the method further comprising:
updating the three-dimensional mesh by mapping the user via non-rigid fusion using the snapshot.

4. The method of claim 3, wherein the three-dimensional mesh of the user includes information related to a most recent number of snapshots of the user, wherein the number of snapshots is set based on threshold value.

5. The method of claim 1, further comprising:
determining the impulse response for the user by processing the three-dimensional mesh through a generative model.

6. The method of claim 5, wherein the generative model is configured to:
process the three-dimensional mesh to determine an embedding vector; and
up-convolve the embedding vector to compute a first output head corresponding to a first ear of the user and a second output head corresponding to a second ear of the user, and
wherein generating the audio stream includes:
determining a first transfer function based on the first output head and a second transfer function based on the second output head, and
generating the audio stream by multiplying frequency spectra of an audio source and the first transfer function and the second transfer function.

7. The method of claim 6, wherein the generative model is configured to convert the three-dimensional mesh to a voxelized three-dimensional grid to determine the embedding vector.

8. The method of claim 1, wherein the at least one physical characteristic of the user includes a first ear and a second ear, and
wherein the impulse response is a first impulse response associated with the first ear,
the method further comprising:
determining a second impulse response associated with the second ear;
generating the audio stream based on the first impulse response and the second impulse response, wherein the audio stream provides a binaural sound of an audio source.

9. The method of claim 8, further comprising:
providing the audio stream, via an electroacoustic transducer, as binaural audio.

10. The method of claim 1, further comprising:
determining a transfer function based on an integral transform of the impulse response for the user; and
generating the audio stream by multiplying frequency spectra of an audio source and the transfer function.

11. The method of claim 10, wherein the transfer function is a Fourier transform of the impulse response.

12. The method of claim 1, wherein the sensor data includes images captured by an imaging device.
